(19) United States
(12) Patent Application Publication
(10) Pub. No.: US 2013/0027817 A1
(43) Pub. Date: Jan. 31, 2013

(54) MICRO ELECTRO-MECHANICAL SWITCH (MEMS) BASED OVER CURRENT MOTOR PROTECTION SYSTEM

(71) Applicants: Remesh Kumar Keeramthode, Secunderabad (IN); Pradeep Kumar Anand, Bangalore (IN); John Kenneth Hooker, Louisville, KY (US); Brent Charles Kumfer, Farmington, CT (US)

(72) Inventors: Remesh Kumar Keeramthode, Secunderabad (IN); Pradeep Kumar Anand, Bangalore (IN); John Kenneth Hooker, Louisville, KY (US); Brent Charles Kumfer, Farmington, CT (US)

(73) Assignee: GENERAL ELECTRIC COMPANY, Schenectady, NY (US)

(21) Appl. No.: 13/190,065

(22) Filed: Jul. 25, 2011

(51) Int. Cl. H02H 3/08

(52) U.S. Cl. 361/31; 361/87

(57) ABSTRACT

An over current protection system includes a current sensing member configured and disposed to output an electrical rate of change signal that is indicative of a rate of change of an electrical current being in excess of a predetermined value, at least one micro electro-mechanical switch (MEMS) device operatively connected to the current sensing member, and a controller electrically coupled to each of the current sensing member and the at least one MEMS device. The controller is configured and disposed to open the at least one MEMS device in response the electrical rate of change signal.

### BACKGROUND OF THE INVENTION

The subject matter disclosed herein relates to the art of motor controls and, more particularly, to a micro electro-mechanical switch (MEMS) based over current motor protection system.

Many conventional electric motors are connected to a motor starter. The motor starter not only provides a mechanism for starting and stopping motor operation but often include a device that protects the motor from an over current or short circuit condition. Short circuit current can cause damage to motor windings. In order to prevent or at least limit over current damage, many motor starters employ current sensing devices that detect current and react at a particular current amplitude. The current sensing devices will cut off current to the motor if the current rises above the particular current amplitude. However, many motors, upon start up, experience an initial in-rush or starting current that is greater than a nominal current rating for the motor. The current sensing device is designed to ignore amplitude peaks associated with starting current to allow the motor to start while at the same time providing short circuit protection. Thus, many existing motor starters monitor for current that exceeds the particular amplitude for a predetermined time period, typically measured in milliseconds.

### BRIEF DESCRIPTION OF THE INVENTION

According to one aspect of the exemplary embodiment, an over current protection system includes a current sensing member configured and disposed to output an electrical rate of change signal indicative of a rate of change of an electrical current being in excess of a predetermined value, at least one micro electro-mechanical switch (MEMS) device operatively connected to the current sensing member, and a controller electrically coupled to each of the current sensing member and the at least one MEMS device. The controller is configured and disposed to open the at least one MEMS device in response to the electrical rate of change signal.

According to another aspect of the exemplary embodiment, a motor controller system includes an electric motor coupled to an electric circuit, a current sensing member configured and disposed to output an electrical rate of change signal indicative of a rate of change of an electrical current in the electric circuit being in excess of a predetermined value, at least one micro electro-mechanical switch (MEMS) device arranged in the electric circuit and operatively connected to the current sensing member the electric motor, a motor controller electrically coupled to each of the current sensing member and the at least one MEMS device. The motor controller is configured and disposed to open the at least one MEMS device in response to the electrical rate of change signal.

According to yet another aspect of the exemplary embodiment, a method of protecting an electrical load from an over current condition includes issuing a Pulse Assist Turn On (PATO) pulse through a PATO circuit to close a micro electro-mechanical switch (MEMS) device electrically coupled to the load through an electric circuit, sensing an electrical current passing through the electric circuit toward the electrical load, monitoring for a rate of change of the electrical current in the electric circuit, determining that the rate of change of the electrical current is in excess of a predetermined value, and issuing signal to open the MEMS device electrically connected to the electric circuit upon detecting that the rate of change of the electrical current is in excess of the predetermined value to prevent electrical current from passing to the electrical load.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a block diagram illustrating an over current protection system in accordance with an exemplary embodiment;

FIG. 2 is a schematic diagram illustrating the over current protection system of FIG. 1; and

FIG. 3 is a flow chart illustrating a method of protecting an electrical load from an over current condition in accordance with an exemplary embodiment.

The detailed description explains embodiments of the invention, together with advantages and features, by way of example with reference to the drawings.

### DETAILED DESCRIPTION OF THE INVENTION

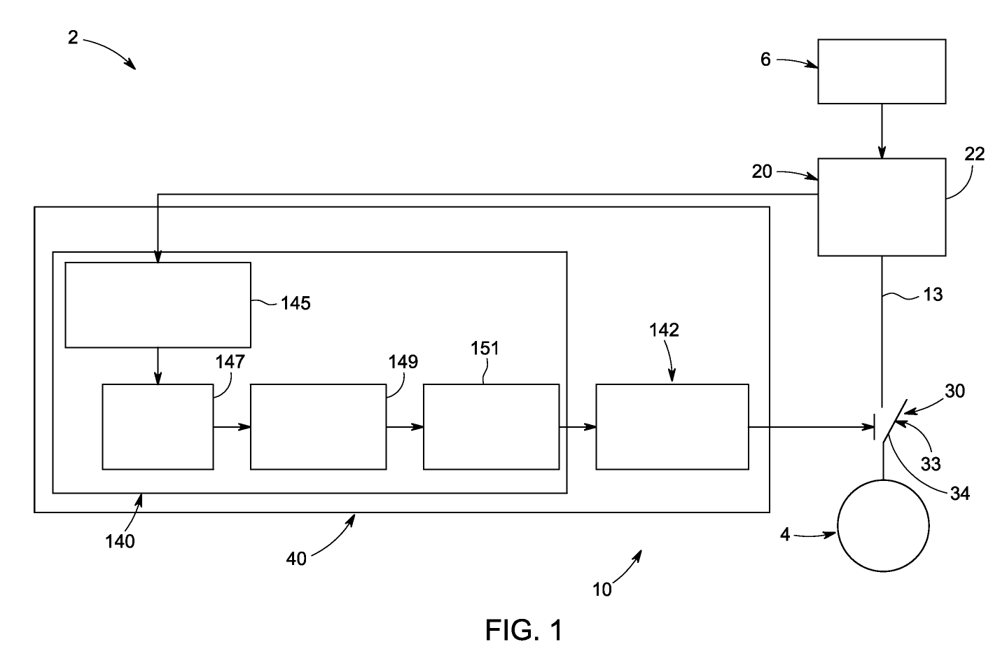

With reference to FIG. 1, a motor controller system in accordance with an exemplary embodiment is indicated generally at 2. Motor controller system 2 includes an electric motor 4 electrically coupled to a power source 6 and an over current protection system 10 through an electric circuit 13. In the exemplary embodiment shown, over current protection system 10 includes a current sensing member 20 that detects a rate of change (di/dt) of current passing through electric circuit 13. In accordance with one aspect of the exemplary embodiment, current sensing member 20 takes the form of a Hall Effect Sensor 22. However, it should be understood that other devices capable of detecting a rate of change of electrical current could also be employed. As will be detailed more fully below, over current protection system 10 is also shown to include a micro electro-mechanical switch (MEMS) device 30 that takes the form of a MEMS die 33 having at least one switch 34 and a controller 40.

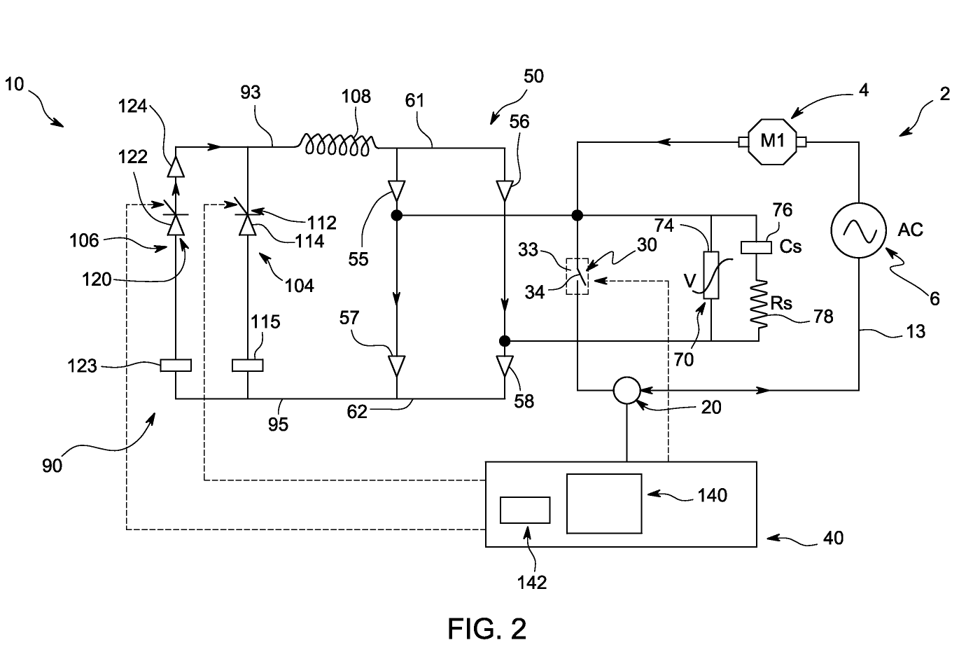

As best shown in FIG. 2, MEMS device 30 is connected across a center point (not separately labeled) of a balanced diode bridge 50 formed by a plurality of corner diodes 55-58. In accordance with an exemplary embodiment, MEMS device 30 is closely coupled to corner diodes 55-58. The term “closely coupled” should be understood to mean that MEMS device 30 is coupled to corner diodes 55-58 with as small of a loop area as possible so as to limit voltage created by stray inductance associated with the loop area is limited to no more than about 1 V. In accordance with one aspect of the exemplary embodiment, the term closely coupled should be interpreted to mean that MEMS device 30 is coupled to corner diodes 55-58 with a loop area in which voltage created by stray inductance is limited to less than about 1 V. The loop area is defined as the area between MEMS device 30 and balanced diode bridge 50. In accordance with one aspect of the exemplary embodiment, an inductive voltage drop across MEMS device 30 during a switching event is controlled by maintaining a small loop inductance between MEMS die 33 and corner diodes 55-58. The inductive voltage across MEMS device 30 during switching is determined by three factors: The length of the loop area which establishes the level of stray inductance; MEMS switch current that is between about 1 Å and about 10 A per parallel leg; and MEMS switching time which is about 1 μsec.

In still further accordance with the exemplary embodiment, the desired loop area can be achieved by, for example, mounting MEMS device 30 on one side of a circuit board (not separately labeled) and corner diodes 55-58 on another side of the circuit board, directly opposite MEMS device 30. In accordance with another example, corner diodes 55-58 could be integrally formed within MEMS die 33. In any event, it should be understood that the particular arrangement of MEMS device 30 and corner diodes 55-58 can vary so long as the loop area, and, by extension, inductance, is maintained as small as possible. It should also be understood that the number of MEMS devices as well as the number of switches carried by a particular MEMS die could vary. While embodiments of the invention are described employing corner diodes 55-58, it will be appreciated that the term “corner” is not limited to a physical location of the diodes, but is rather directed to a placement of the diodes relative to the MEMS die 33.

As discussed above, corner diodes 55-58 are arranged in balanced diode bridge 50 so as to provide a low impedance path for load current passing through MEMS device 30. As such, corner diodes 55-58 are arranged so as to limit inductance which, in turn, limits voltage changes over time, i.e., voltage spikes across MEMS device 30. In the exemplary embodiment shown, balanced diode bridge 50 includes a first branch 61 and a second branch 62. As used herein, the term “balanced diode bridge” describes a diode bridge that is configured such that voltage drops across both the first and second branches 61 and 62 are substantially equal when current in each branch 61, 62 is substantially equal. In first branch 61, diode 55 and diode 56 are coupled together to form a first series circuit (not separately labeled).

In a similar fashion, second branch 61 includes diode 57 and diode 58 operatively coupled together to form a second series circuit (also not separately labeled). Over current protection system 10 is also shown connected to a voltage snubber 70 that is connected in parallel relative to MEMS device 30 as well as power source 6 and electric motor 4. Voltage snubber 70 limits voltage overshoot during fast contact separation of each of MEMS switch 34. Voltage snubber 70 is shown in the form of a metal-oxide varistor (MOV) 74. MOV 74 is shown coupled to a snubber capacitor 76 that is connected in series with a snubber resistor 78. Snubber capacitor 76 and snubber resistor 78 are electrically connected in parallel to MOV 74.

In further accordance with the exemplary embodiment, over current protection system is shown to include a single Hybrid Arcless Limiting Technology (HALT)/Pulse Activated Turn On (PATO) circuit 90. HALT/PATO circuit 90 includes a first branch 93 that is electrically connected to first branch 61 of balanced diode bridge 50 and a second branch 95 that is electrically connected to second branch 62 of balanced diode bridge 50. HALT/PATO circuit 90 includes a HALT circuit portion 104 and a PATO circuit portion 106 electrically connected between first and second branches 61 and 62 through common inductor 108.

HALT circuit portion 104 is connected in parallel to PATO circuit portion 106. HALT circuit portion 104 includes a HALT switch 112 shown in the form of a switching device 114. Switching device 114 is connected in series with a HALT capacitor 115. PATO circuit portion 106 includes a pulse switch 120 shown in the form of a switching device 122 connected in series with a pulse capacitor 123 and a pulse diode 124. Inductor 108 is connected in series to HALT and PATO circuit portions 104 and 106 in first branch 93. As will become more fully evident below, HALT switch 112 is selectively closed to open MEMS die 33, and pulse switch 120 is selectively closed to close MEMS die 33. That is, HALT switch 112 is closed to electrically power HALT circuit portion 104 to open MEMS device 30, and pulse switch 120 is closed to electrically power PATO circuit portion 106 to close MEMS device 30. The closing of MEMS device 30 completes electric circuit 13 allowing electrical current to flow from power source 6 to electric motor 4. Conversely, opening MEMS device 30 disrupts the flow of electrical current between power source 6 and electric motor 4.

In still further accordance with the exemplary embodiment, controller 40 includes a short circuit detection portion 140 electrically coupled to a motor drive portion 142. Motor drive portion 142 selectively signals PATO circuit portion 106 and HALT circuit portion 104 to close and open MEMS device 30 in response to a motor start signal and a motor stop signal. In addition, motor drive portion 142 will signal HALT circuit portion 104 to open MEMS device 30 in the event of an over current condition signaled by short circuit detection portion 140. Short circuit detection portion 140 includes an operational amplifier (Op Amp) 145 electrically coupled to a rectifier 147, a comparator 149 and a micro-controller 151. Op Amp 145 generates a rate of change (di/dt) signal based in inputs from current sensing member 20. The rate of change signal is passed to rectifier 147. Rectifier 147 converts the rate of change signal into a unipolar rate of change signal that is passed to comparator 149. Comparator 149 compares the unipolar rate of change signal with a predetermined threshold value. If the unipolar rate of change signal is above the predetermined threshold value, an output signal is passed to motor drive portion 142 via micro-controller 151 to activate HALT circuit portion 104 and open MEMS device 30 cutting off the flow of electrical current in electric circuit 13 to protect electric motor 4 from over or short circuit current.

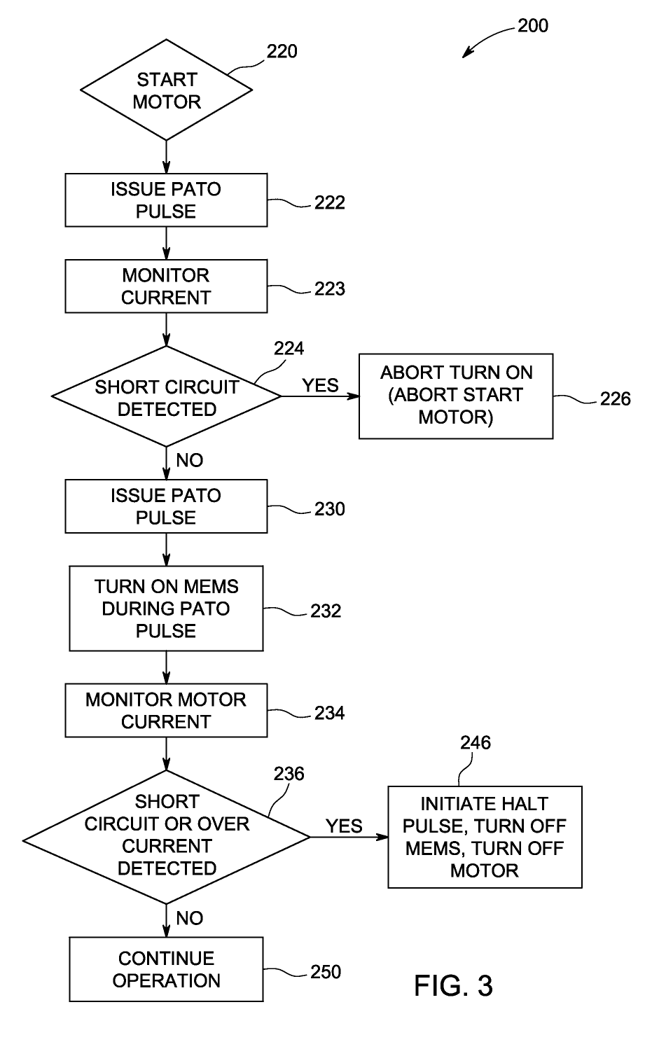

Reference will now be made to FIG. 3 in describing a method 200 of protecting electric motor 4 from an over or short circuit condition. Initially, controller 40 receives a motor start signal/request as indicated in block 220. Upon receipt of the start signal, motor drive portion 142 signals pulse switch 120 to close and send a PATO pulse through PATO circuit portion 106 to close MEMS device 30 as indicated in block 222. At this point, short circuit detection portion 140 begins to monitor the rate of change of the electrical current in block 223 and determine, in block 224, whether a short circuit condition exists. If the detected rate of change exceeds the predetermined threshold value, motor starting is aborted, the signal is cut off to pulse switch 120 and a signal is sent to HALT switch 112 to open MEMS device 30 as indicated in block 226. Of course it should be understood that the predetermined threshold value for motor starting may be different than the predetermined threshold value for a running condition to account for any differences associated with motor starting current.

If no short circuit is detected upon start up, a second PATO pulse is issued as indicated in block 230 and MEMS device 30 is turned on or closes to connect electric motor is connected to power source 6 as indicated in block 232. At this point, short circuit detection system 140 monitors for the rate of change of current as indicated in block 234 and determine, as indicated in block 236, whether a post start short circuit condition exists. If a short circuit is detected in block 236 a HALT pulse is dent through HALT circuit 104 to signal MEMS device 30 to open MEMS switch to cease motor operation as indicted in block 246, otherwise electric motor 4 continues normal operation as indicated in block 250

At this point, it should be understood that the exemplary embodiments provide a system to monitor for over current conditions to protect an electrical load such as an electric motor. In contrast to prior art arrangements that monitor for changes in an amplitude of electric current, the exemplary embodiments monitor an electrical current rate of change. In this manner, the exemplary embodiments provide a faster response time that reduces the electric motor's risk of exposure to short circuit currents. In addition, the use of a MEMS device to cut off current flow provides a response time that is nearly an order of magnitude faster than existing systems. More specifically, the use of MEMS devices reduces circuit reaction time to no more than about 16 μsecs.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An over current protection system comprising:
a current sensing member configured and disposed to output an electrical rate of change signal indicative of a rate of change of an electrical current being in excess of a predetermined value;
at least one micro electro-mechanical switch (MEMS) device operatively connected to the current sensing member; and
a controller electrically coupled to each of the current sensing member and the at least one MEMS device, the controller being configured and disposed to open the at least one MEMS device in response to the electrical rate of change signal from the current sensing member.

2. The over current protection system according to claim 1, further comprising: a diode bridge closely coupled to the at least one MEMS device.

3. The over current protection system according to claim 2, wherein the diode bridge is coupled to the at least one MEMS device through a loop area in which stray inductance is limited to between no more than about 1 V.

4. The over current protection system according to claim 2, wherein the diode bridge is coupled to the at least one MEMS device through a loop area in which stray inductance is limited to less than about 1 V.

5. The over current protection system according to claim 2, further comprising: a Pulse Assist Turn-On (PATO) circuit electrically coupled to the diode bridge.

6. The over current protection system according to claim 2, further comprising: a Hybrid Arcless Limiting Technology (HALT) circuit electrically coupled to the diode bridge.

7. The over-current protection system according to claim 1, wherein the controller includes at least one micro-controller, and at least one of an operational amplifier, a rectifier, and a comparator, the micro-controller being operatively coupled to the at least one operational amplifier, rectifier and comparator.

8. A motor controller system comprising:
an electric motor coupled to an electric circuit;
a current sensing member configured and disposed to output an electrical rate of change signal indicative of a rate of change of an electrical current in the electric circuit being in excess of a predetermined value;
at least one micro electro-mechanical switch (MEMS) device arranged in the electric circuit and operatively connected to the current sensing member and the electric motor; and
a motor controller electrically coupled to each of the current sensing member and the at least one MEMS device, the controller being configured and disposed to open the at least one MEMS device in response to the electrical rate of change signal.

9. The motor controller system according to claim 8, further comprising: a diode bridge closely coupled to the at least one MEMS device.

10. The motor controller according to claim 9, wherein the diode bridge is coupled to the at least one MEMS device through a loop area in which stray inductance is limited to about 1 V.

11. The motor controller according to claim 9, wherein the diode bridge is coupled to the at least one MEMS device through a loop area in which stray inductance is limited to less than about 1 V.

12. The motor controller system according to claim 8, further comprising: a Pulse Assist Turn-On (PATO) circuit electrically coupled to the diode bridge.

13. The motor controller system according to claim 8, further comprising: a Hybrid Arcless Limiting Technology (HALT) circuit electrically coupled to the diode bridge.

14. The motor controller system according to claim 8, wherein the controller includes at least one micro-controller, operatively coupled to an operational amplifier, a rectifier, and a comparator.

15. A method of protecting an electrical load from an over current condition, the method comprising:
issuing a Pulse Assist Turn On (PATO) pulse through a PATO circuit to close a micro electro-mechanical switch (MEMS) device electrically coupled to the load through an electric circuit;
sensing an electrical current passing through the electric circuit toward the electrical load;
monitoring for a rate of change of the electrical current in the electric circuit;
determining that the rate of change of the electrical current is in excess of a predetermined value; and
issuing a signal to open the MEMS device upon detecting that the rate of change of the electrical current is in excess of the predetermined value.

16. The method of claim 15, further comprising:
passing the electrical current to the electrical load if the rate of change of the electrical current is below the predetermined value; and
monitoring the electrical current.

17. The method of claim 15, further comprising: issuing a Hybrid Arcless Limiting Technology (HALT) signal to open the MEMS device if the rate of change of the electrical current exceeds the predetermined value.

18. The method of claim 15, wherein the MEMS device is configured to open after no more than 16 μsec of detecting the rate of change of the electrical current in excess of the predetermined value.
